(19) United States
(12) Patent Application Publication
(10) Pub. No.: US 2004/0020414 A1
(43) Pub. Date: Feb. 5, 2004

(54) Method for generating energy

(76) Inventor: Norbert Auner, Frankfurt (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/311,425

(22) PCT Filed: Jun. 15, 2001
(86) PCT No.: PCT/DE01/02231

(51) Int. Cl. F23B 7/00; C07F 7/04

(52) U.S. Cl. 110/341; 556/469

(57) ABSTRACT

A process for the generation of energy by the combustion of silicon compounds having the bonds Si—C, Si—O, Si—Si and/or Si—H is described. Such compounds are appropriate energy carriers as alternative with respect to hydrocarbons.

The present invention is directed to a process for the generation of energy.

The actual concept for the generation of energy is substantially based on carbon (crude oil, natural gas) as raw material source. Not only the times of the “oil crisises” of the past confirm that this raw material will be available in the future only in a progressively reduced extent. Also scientific calculations show that our natural carbon resources become progressively exhausted. If one only takes into account the warning discussions of a necessary CO₂ reduction in the atmosphere of the earth it becomes obvious that the search for and the investigation of alternative energy sources become conclusively necessary.

None of the worldwide discussed concepts of alternative forms of energy and energy generation emanates from “quartz sand” (silica), i.e. a non-poisonous natural substance, which is available in an unlimited manner. About 75% of the accessible earth crust including the different kinds of “biomass” as plants, stones, diatomacae (in salt water) and much more consist of silicon dioxide (SiO₂(Si: 26.3% O₂: 48.9%). Accordingly, the Si is as frequent as all the other elements together, or four or five atoms of the earth crust are Si or O. Silicon dioxide is converted into crystalline silicon by a reduction process (with coal in an electric arc process), the crystalline silicon (i), after post-treatment for the generation of purest silicon, being used for certain hightech applications, as for instance semiconductors, which are particularly used in transistors and integrated circuits, and (ii) being used for the “direct synthesis” (Müller Rochow synthesis). According to this synthesis elementary silicon is converted to dimethyldichlorosilane (about 95%, Me₂SiCl₂, boiling point 70° C.) with methylchloride at a copper catalyst (T=280-320° C., fluidization or fluidized bed reactor). The obtained dimethyldichlorosilane serves as starting product for the generation of the silicones, i.e. plastics on Si—O base, which are today worldwidely produced in the extent of megatons and are variously used. Byproducts of the “direct synthesis” are also tetramethylsilane (Si(CH₃)₄(TMS)) and disilanes and trisilanes, i.e. compounds with Si—Si bond, in addition to different chlorine and H containing silanes. The “direct synthesis” has three substantial disadvantages in the technology carried out today: It is (a) relative expensive since essential amounts of energy are necessary for the reduction of the SiO₂ to Si, and (b) when carrying out the methylation energy is again set free which is only insufficiently utilized up to now. Furthermore, (c) the byproducts reduce the efficiency since the same are expensively converted into chlorosilanes or are burnt to pyrogenic silicic acid. Moreover, disilanes and trisilanes have to be expensively disposed.

It is the object of the present invention to indicate a process for the generation of energy which can be carried out in a simple and economic manner and with which no hydrocarbon compounds are burnt.

According to the invention this object is achieved by a process for the generation of energy by the combustion of silicon compounds having the bonds Si—C, Si—O, Si—Si and/or Si—H.

By investigations and measurements it was ascertained that a plurality of silicon compounds established of Si—C, Si—L, Si—Si and or Si—H bonds exist which have a combustion heat coming very close to that of pure hydrocarbons. For instance, for tetramethylsilane (TMS) a combustion heat was measured which corresponds to 95% of the energy density of decane. Even for a cyclosilane containing exclusively Si—Si and Si—H bonds values were ascertained reaching for about 75% the values for decane (C₁₀H₂₂). Accordingly, such silicon compounds can be used as energy supplying substances, for instance for the production of heat energy and propulsion energy (in combustion engines, jets, rocket propulsion units etc.).

The term “combustion” which is used here has the meaning of an oxidation process, i.e. a conversion with oxygen. The combustion results in silicon dioxide (SiO₂) and water (H₂O), i.e. non-poisonous substances. If compounds are used which contain Si—C bonds, carbon dioxide (CO₂) is produced as further combustion product. The higher the content of Si is the more SiO₂ (sand) is generated, the higher the C content is the more CO₂ is generated. By the design of appropriate silicon compounds the CO₂/SiO₂ ratio can be varied. The generated SiO₂ can be collected and possibly recycled.

Accordingly, with the inventive process a cycle “sand→energy→sand” can be constructed which is interesting even with respect to another aspect: Si alkyl compounds are as SiO₂ non-toxic, self-igniting or air sensitive. Dependent on the demand and the application a compound with defined boiling point or boiling range can be used. Accordingly, for instance tetramethylsilane has a boiling point of 25-30° C. which corresponds to the boiling point of liquid gas under pressure. Consequently, if necessary, the product can be easily evaporated and thus exactly metered (for instance in injection nozzles or injection pumps).

According to a variant of the inventive process byproducts generated in the preplaced Müller Rochow synthesis of the production of silicones are burnt. Accordingly, with this variant the byproducts of a process which were expensively converted to further products or which were expensively disposed up to now are used for the generation of energy by combustion. The inventive process also includes a variant according to which byproducts generated in the preplaced Miller Rochow synthesis are further processed for the generation of appropriate silicon compounds having the bonds Si—C, Si—O, Si—Si and/or Si—H which serve as energy carrier.

Preferably, according to the invention silanes, especially carbosilanes, are burnt. Suitable silanes are for instance the following compounds wherein R is an organoradical: SiR₄, (R₂Si)ₙ, (H₂Si)ₙ, [R(H)Si]ₙ, H₃Si(SiR₂)ₙSiH₃ and R₃Si(SiH₂)ₙSiR₃. By an appropriate selection the CO₂/SiO₂ ratio obtained by the combustion can be arbitrarily varied.

As regards the carbosilanes, generally the following can be said: The larger the CH chain at the Si center is the more the energy contents of corresponding hydrocarbons are approached. The longer the Si chain (in polysilanes (R₂Si)ₙ) is the more the 75% value (combustion heat) of pure polysilane is approached.

Accordingly, the use of silanes, especially carbosilanes, as energy source is possible in the same manner for a propulsion motor as for a heating system, i.e. for all which can be obtained with hydrocarbons.

In the following the invention is described by means of an example.

The tetramethylsilane (Si(CH₃)₄) generated in the “direct synthesis” (Müller Rochow synthesis) was burnt. The generated combustion heat was measured wherein a value was ascertained which corresponded to 95% of the energy density of decane (C₁₀R₂₂). Accordingly, the used carbosilane had an energy density comparable with that of hydrocarbons.

1. A process for the generation of energy by the combustion of silicon compounds having the bonds Si—C, Si—O, Si—Si and/or Si—H.

2. The process according to claim 1, characterized in that byproducts are burnt generated in a preplaced Müller Rochow synthesis in the production of silicones.

3. The process according to claim 1, characterized in that byproducts generated in a preplaced Müller Rochow synthesis in the production of silicones are further processed for the generation of silicon compounds with the bonds Si—C, Si—O, Si—Si and/or Si—H.

4. The process according to one of the preceding claims, characterized in that silanes, especially carbosilanes, are burnt.

5. The process according to one of the preceding claims, characterized in that tetramethylsilane is burnt.
